(19) United States
(12) Patent Application Publication
(10) Pub. No.: US 2008/0025512 A1
(43) Pub. Date: Jan. 31, 2008

(54) COMMUNICATION APPARATUS, CONTROL METHOD THEREFOR, AND COMPUTER PROGRAM ALLOWING COMPUTER TO EXECUTE THE SAME

(75) Inventor: Takafumi Nakajima, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/782,454

(22) Filed: Jul. 24, 2007

(30) Foreign Application Priority Data
Jul. 31, 2006 (JP) 2006-208494

(51) Int. Cl. H04L 9/00

(52) U.S. Cl. 380/270

(57) ABSTRACT

Communication between apparatuses is performed by switching an operation mode or a communication mode in the apparatuses based on an encryption method to be used for communication between the apparatuses. For example, in the case that two communication apparatuses are communicating with each other in a first communication mode using a first encryption method, if a request to change to a second encryption method is issued, one communication apparatus switches its operation mode, whereby the communication apparatuses communicate in a second communication mode.

### BACKGROUND OF THE INVENTION

1. Field of the Invention

The present invention relates to communication apparatuses, control methods therefor, and computer programs for allowing a computer to execute the same.

2. Description of the Related Art

Recently, communication systems using a wireless local area network (LAN) based on the Institute of Electrical and Electronics Engineers (IEEE) 802.11 standard have become increasingly popular.

This wireless LAN systems have two communication modes: infrastructure mode (hereinafter abbreviated as “infra”) in which terminals communicate with each other via an access point (AP), and ad hoc mode (hereinafter abbreviated as “ad hoc”) in which terminals directly communicate with each other without an AP interposed therebetween.

Generally, wireless LAN communication selects one of the two communication modes, that is, infra or ad hoc, and performs communication.

The technique of switching between infra and ad hoc based on the communication traffic or the like has been proposed in, for example, Japanese Patent Laid-Open Nos. 2004-229237 and 2004-349777.

However, IEEE 802.11i (security standard of IEEE 802.11) defines different encryption methods to be employed in infra and ad hoc. IEEE 802.11i defines three encryption methods: Wired Equivalent Privacy (WEP), Temporal Key Integrity Protocol (TKIP), and Advanced Encryption Standard (AES).

The encryption strength is the highest in AES, which is followed by TKIP and WEP in descending order. Note that TKIP and AES require complicated processing to determine an encryption key for communication. Infra, where the AP performs central control, can handle such complicated processing. Thus, most devices support TKIP and AES in infra.

However, ad hoc, where terminals are equivalent to one another, involves complicated negotiation in performing TKIP and AES. Therefore, at present, most devices do not support TKIP and AES in ad hoc.

In contrast to TKIP and AES, WEP does not involve complicated processing to determine an encryption key. Therefore, most devices support WEP both in infra and ad hoc.

In many cases, communication using AES or TKIP cannot be performed in ad hoc. Compared with infra, ad hoc has a lower level of security.

### SUMMARY OF THE INVENTION

The present invention implements communication in a communication mode according to an encryption method to be used.

According to an aspect of the present invention, there is provided a communication system including a first communication apparatus, and a second communication apparatus, wherein the first and second communication apparatuses each include a first operation mode in which the communication apparatus operates as a control station in a wireless network, and a second operation mode in which the communication apparatus operates as a terminal station in the wireless network. An encryption method to be used for communication between the first and second communication apparatuses is determined, wherein the first communication apparatus selectively switches between the first and second operation modes based on the determined encryption method, and the first and second communication apparatuses communicate with each other using the determined encryption method and the switched operation mode.

According to another aspect of the present invention, there is provided a communication apparatus including a first operation mode in which the communication apparatus operates as a control station in a wireless network and a second operation mode in which the communication apparatus operates as a terminal station in the wireless network, the communication apparatus including a determining unit configured to determine an encryption method to use for communication, a switching unit configured to selectively switch between the first and second operation modes based on the encryption method determined by the determining unit, and a communication unit configured to communicate in the communication mode switched to by the switching unit.

Further features of the present invention will become apparent from the following description of exemplary embodiments with reference to the attached drawings.

### BRIEF DESCRIPTION OF THE DRAWINGS

FIG. 1 is a diagram illustrating a system configuration according to a first embodiment of the present invention.

FIG. 2 is a block diagram of a dual apparatus.

FIG. 3 is a block diagram of a legacy apparatus.

FIG. 4 illustrates exemplary lists of encryption methods supported by communication apparatuses.

FIG. 5 is a sequence diagram between a communication apparatus 101 and a communication apparatus 102 according to the first embodiment.

FIG. 6 is a flowchart of an encryption-method determining process performed by the dual apparatus.

FIG. 7 is a flowchart of an encryption-method changing process performed by the dual apparatus.

FIG. 8 is flowchart of an encryption-method change responding process performed by the dual apparatus.

FIG. 9 is a flowchart of an encryption-method changing process performed by the legacy apparatus.

FIG. 10 illustrates exemplary lists of encryption methods supported by the communication apparatuses.

FIG. 11 is a sequence diagram between the communication apparatus 101 and the communication apparatus 102 according to the first embodiment.

FIG. 12 is a diagram illustrating a system configuration according to a second embodiment of the present invention.

FIG. 13 is a sequence diagram among a communication apparatus 1201, a communication apparatus 1202, and a communication apparatus 1203 according to the second embodiment.

FIG. 14 is a diagram illustrating a system configuration according to a third embodiment of the present invention.

FIG. 15 is a sequence diagram among a communication apparatus 1401, a communication apparatus 1402, and an access point 1404 according to the third embodiment.

### DESCRIPTION OF THE EMBODIMENTS

Exemplary preferred embodiments of the present invention will now herein be described in detail below with reference to the drawings. The present invention is not limited to the embodiments, and various modifications can be made without departing from the technical spirit and scope of the present invention.

In each of the embodiments, exemplary cases of communication using an IEEE 802.11 wireless LAN (hereinafter referred to as a “wireless LAN”) will be described.

As described above, infra is a communication mode in which a plurality of terminal stations communicate wirelessly with one another via a base station referred to as an access point (AP). An AP functions as a repeater relaying communication signals among the terminal stations. Terminal stations whose communication mode has been set to infra communicate with other terminal stations via the AP. As previously described, ad hoc is a communication mode in which a plurality of terminal stations directly communicate with one another without involving an AP. Therefore, terminal stations whose communication mode has been set to ad hoc directly wirelessly exchange packets and communicate with other terminal stations.

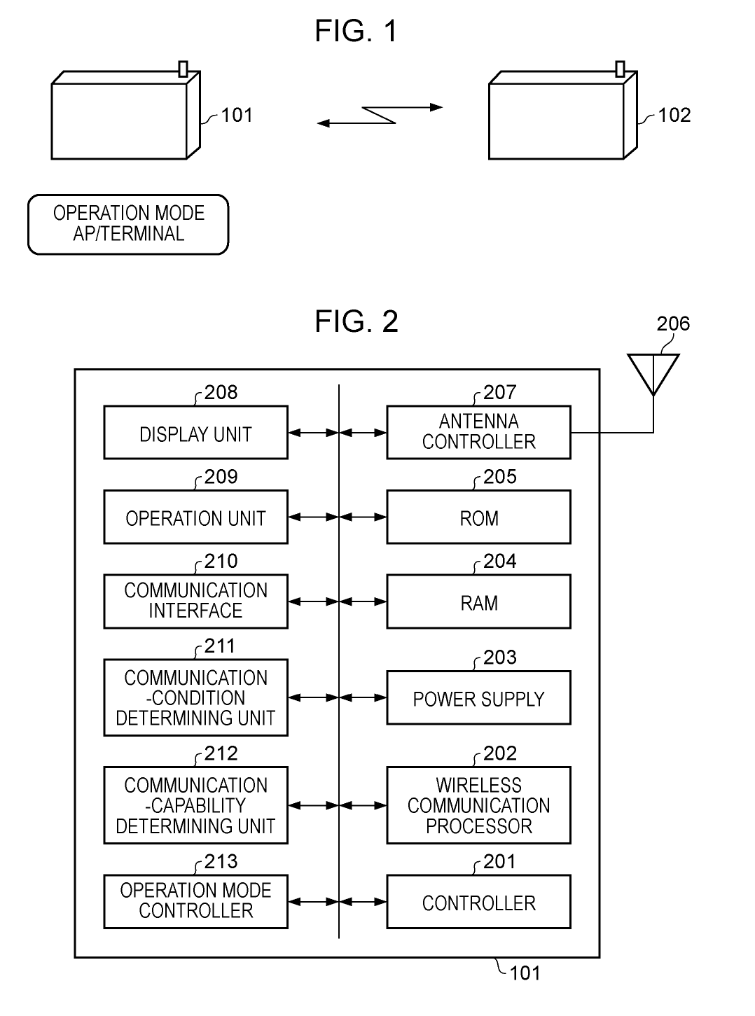

FIG. 1 illustrates a system configuration according to a first embodiment of the present invention.

A communication apparatus 101 has a communication function using a wireless LAN. The communication apparatus 101 has two operation modes, i.e., AP mode and terminal mode, and switches between the two operation modes. Hereinafter, a communication apparatus having a function of switching between the AP mode and the terminal mode (hereinafter referred to as a “dual function”) will be referred to as a “dual apparatus”.

A communication apparatus 102 has a communication function using a wireless LAN, but does not have the above-mentioned dual function. That is, the communication apparatus 102 is a communication apparatus that only has the function as a wireless LAN terminal station. Hereinafter, a communication apparatus that only has a function as a wireless LAN terminal station is referred to as a “legacy apparatus”.

The AP mode is an operation mode in which an apparatus operates as an AP. In the case that a dual apparatus operates in the AP mode, the dual apparatus can communicate in the infra with a legacy apparatus or another dual apparatus operating in the terminal mode. A dual apparatus operating in the AP mode has a function of controlling communication with a legacy apparatus or another dual apparatus operating in the terminal mode. The dual apparatus operating in the AP mode can also relay communication signals between legacy apparatuses or dual apparatuses operating in the terminal mode and can also directly communicate with these apparatuses.

The terminal mode is an operation mode in which an apparatus operates as a wireless LAN terminal station. In the case that a dual apparatus operates in the terminal mode, the dual apparatus can perform communication in infra under control of an AP or another dual apparatus operating in the AP mode. The dual apparatus operating in the terminal mode can also perform direct communication in the ad hoc with a legacy apparatus or another dual apparatus operating in the terminal mode. In other words, the above-mentioned legacy apparatus is a communication apparatus that only has the terminal mode.

FIG. 2 is a block diagram of the communication apparatus 101 according to the first embodiment. The communication apparatus 101 includes a controller 201 configured to control the communication apparatus 101, a wireless communication processor 202 configured to control wireless LAN communication, and a power supply 203.

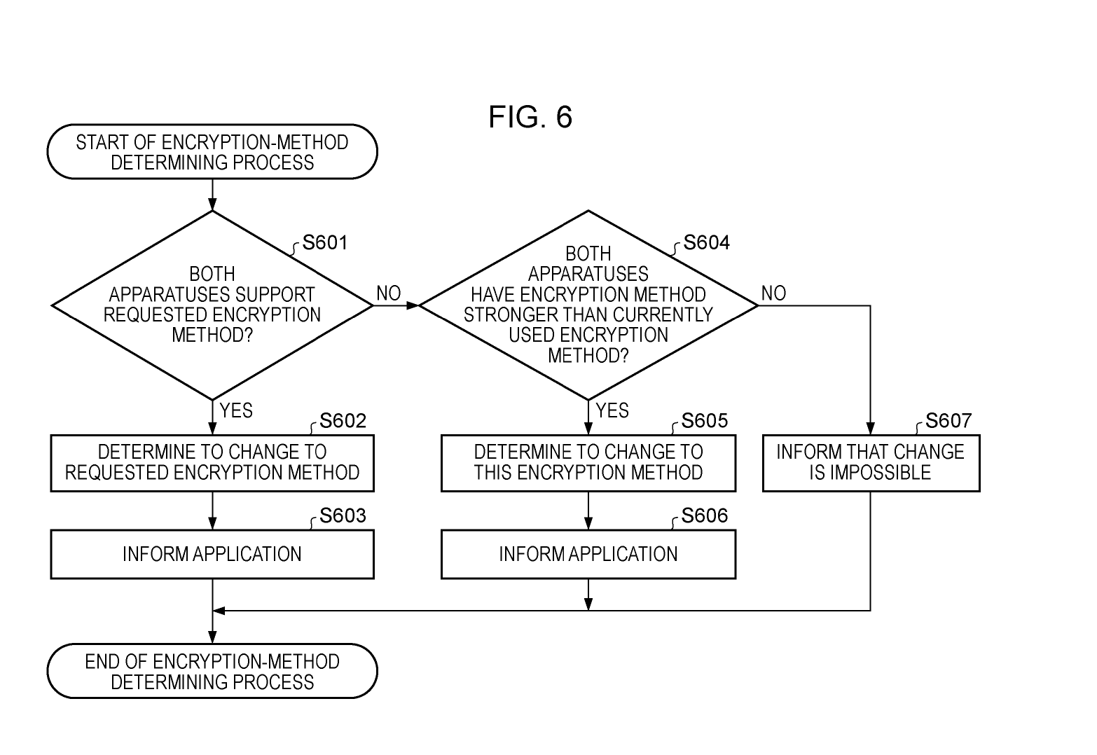

The communication apparatus 101 further includes a random access memory (RAM) 204 and a read only memory (ROM) 205 that stores operation programs for implementing the operation illustrated in FIGS. 6 through 8, which will be described later.

The communication apparatus 101 further includes an antenna 206, an antenna controller 207, a display unit 208, an operation unit 209, and a communication interface 210, such as universal serial bus (USB) or IEEE 1394, other than wireless communication interface.

The communication apparatus 101 further includes a communication-condition determining unit 211 configured to determine a communication condition, a communication-capability determining unit 212 configured to determine the capability of a communication partner, and an operation mode controller 213 configured to switch the operation mode.

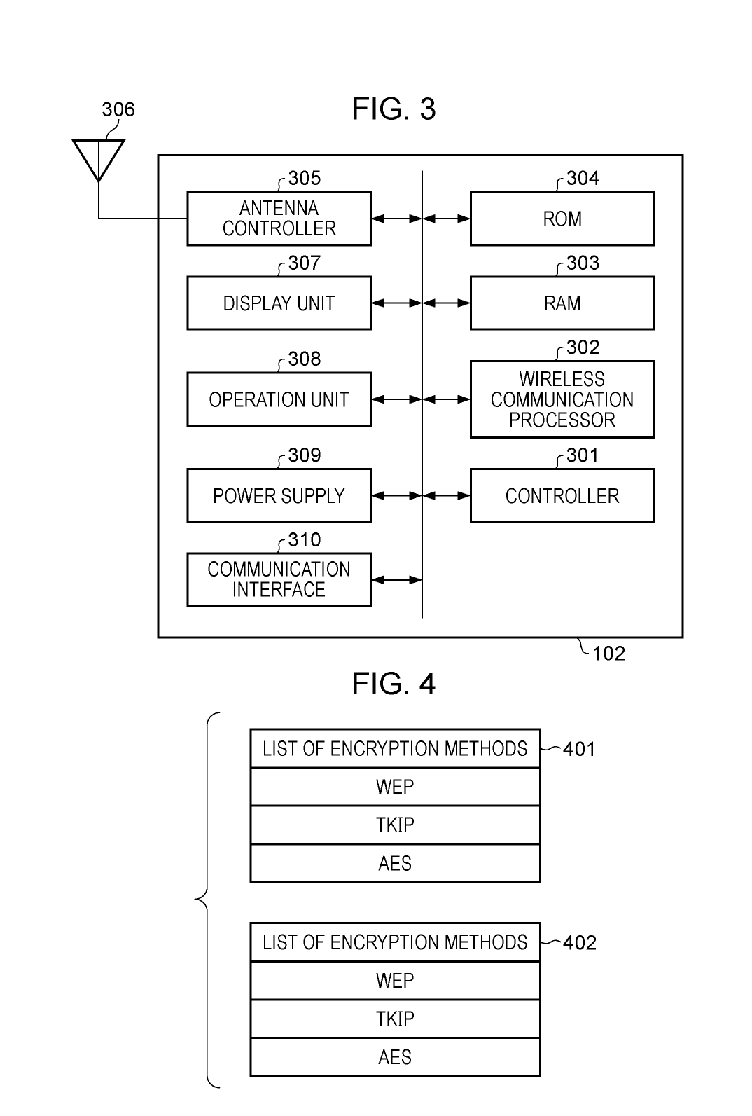

FIG. 3 is a block diagram of the communication apparatus 102 according to the first embodiment. The communication apparatus 102 includes a controller 301 configured to control the communication apparatus 102 and a wireless communication processor 302 configured to control wireless LAN communication.

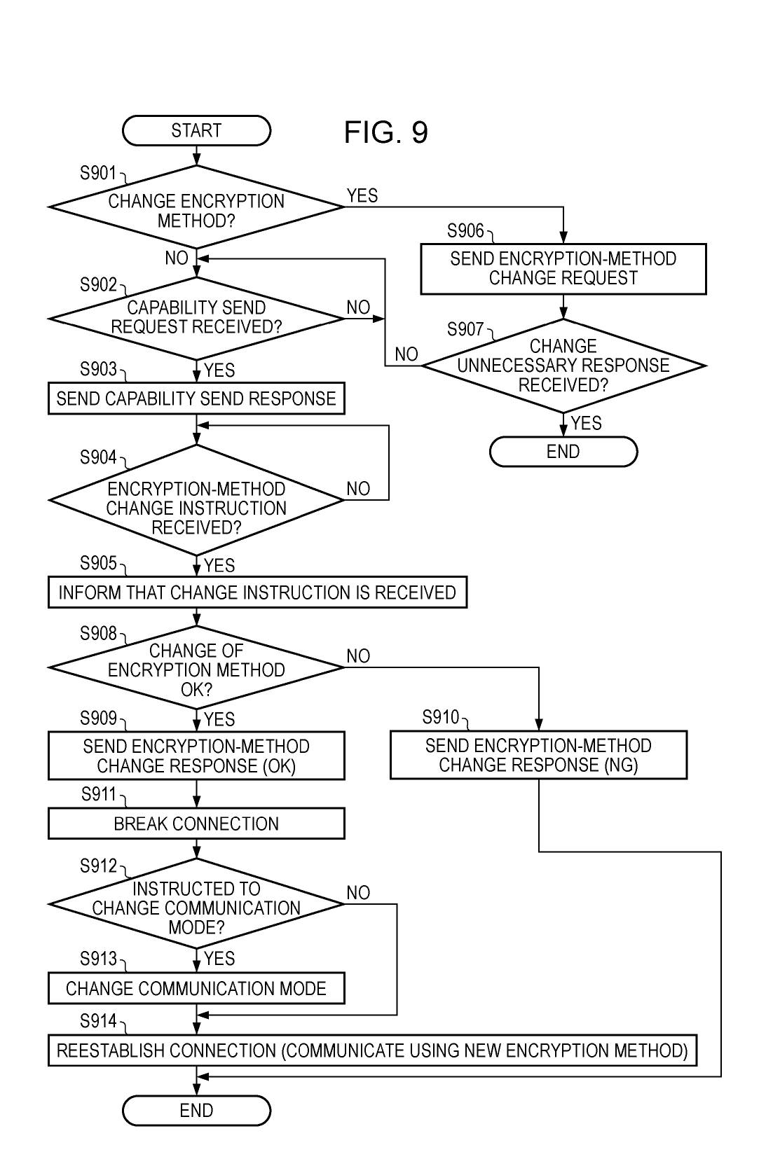

The communication apparatus 101 further includes a RAM 303 and a ROM 304 that stores operation programs for implementing the operation illustrated in FIG. 9, which will be described later.

The communication apparatus 101 further includes an antenna controller 305, an antenna 306, a display unit 307, an operation unit 308, a power supply 309, and a communication interface 310, such as USB or IEEE 1394, other than wireless communication interface.

FIG. 4 illustrates exemplary lists of encryption methods supported by the communication apparatuses 101 and 102 in infra according to the first embodiment.

An encryption method list 401 is a list of encryption methods supported by the communication apparatus 101, and an encryption method list 402 is a list of encryption methods supported by the communication apparatus 102.

In infra, both the communication apparatuses 101 and 102 support WEP, TKIP, and AES. The encryption strength is the highest in AES, which is followed by TKIP and WEP in descending order. In ad hoc, the communication apparatuses 101 and 102 support only WEP.

In the case that WEP is used, the communication apparatuses 101 and 102 can perform communication both in infra and ad hoc. However, in the case that TKIP or AES is used, the communication apparatuses 101 and 102 can perform communication only in infra.

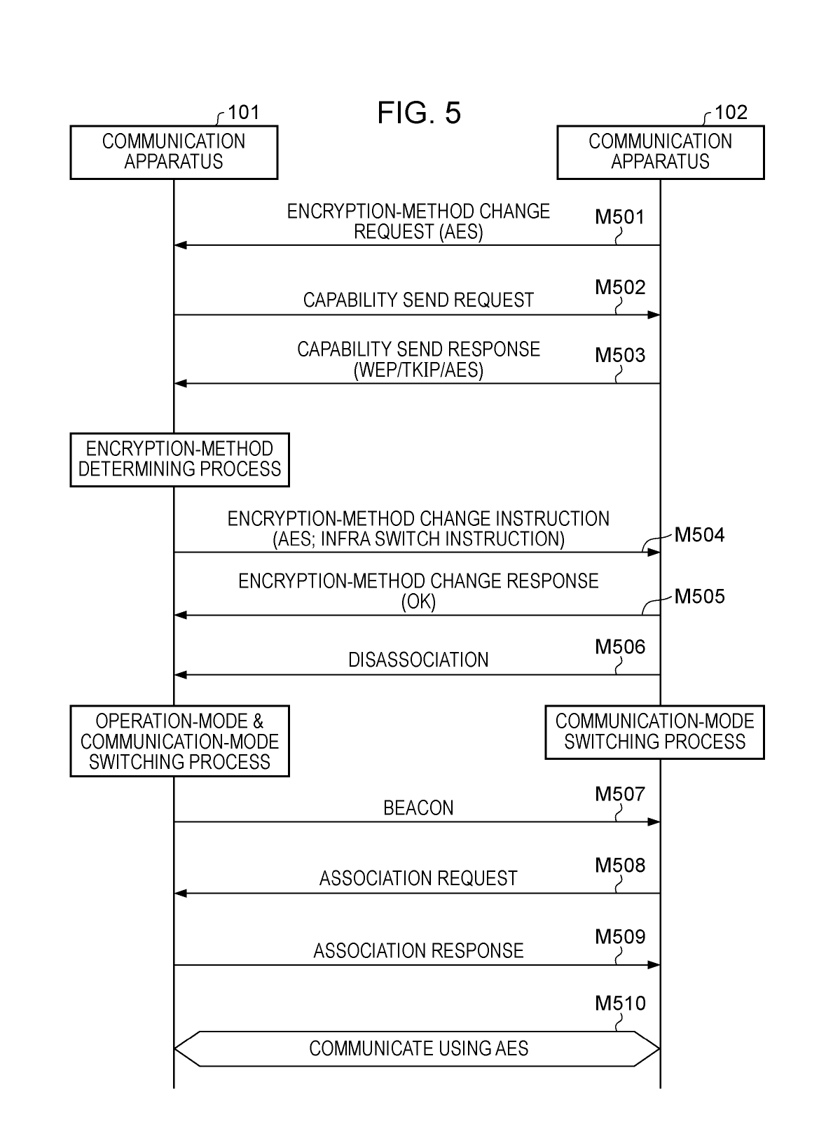

FIG. 5 is a diagram of an encryption-method changing sequence in the case that encryption methods supported by the communication apparatuses 101 and 102 in infra correspond to the encryption method lists 401 and 402 (FIG. 4), respectively.

In this sequence, the operation mode of the communication apparatus 101 has been set to the terminal mode, and the communication apparatus 101 is communicating with the communication apparatus 102 in ad hoc (where the encryption method is WEP).

The case in which the communication apparatus 102 serving as a legacy apparatus sends a request for communication using AES, which is a stronger encryption method than WEP, to the communication apparatus 101 serving as a dual apparatus will be described.

To change the encryption method to AES, the communication apparatus 102 sends an encryption-method change request message (M501) to the communication apparatus 101. Upon receipt of the encryption-method change request message (M501), the communication apparatus 101 sends a capability send request message (M502) to the communication apparatus 102.

Upon receipt of the capability send request message (M502), the communication apparatus 102 stores the encryption methods supported in infra by the communication apparatus 102 in a capability send response message (M503) and sends the capability send response message (M503) to the communication apparatus 101. As has been described above, according to the present embodiment, the communication apparatus 102 supports the encryption methods WEP, TKIP, and AES. Alternatively, the processing to collect the capability (M502 and M503) may be performed in advance, regardless of whether an encryption-method change request message is received or not.

Upon receipt of the capability send response message (M503), the communication apparatus 101 performs an encryption-method determining process. Since AES, which is the requested encryption method, is supported by both the communication apparatus 101 and the communication apparatus 102, the communication apparatus 101 determines to change the encryption method to AES. To change the encryption method to AES, the mode of communication between the communication apparatus 101 and the communication apparatus 102 must be changed from ad hoc to infra.

Therefore, the communication apparatus 101 sends an encryption-method change instruction message (M504), including an instruction to change the encryption method to AES and an instruction to switch the mode to infra, to the communication apparatus 102. Upon receipt of the encryption-method change instruction message (M504), the communication apparatus 102 sends an encryption-method change response message (M505) to the communication apparatus 101 in order to respond that the encryption method can be changed to AES.

Next, the communication apparatus 102 sends a disassociation (M506) to the communication apparatus 101 to break the connection with the communication apparatus 101. The breaking processing is not limited to the disassociation (M506) and may include processing required to reestablish connection. After the connection has been broken, the communication apparatus 101 switches its operation mode to the AP mode and its communication mode to infra. After the connection has been broken, the communication apparatus 102 switches its operation mode to infra.

Next, the communication apparatus 101 sends a beacon (M507) in order to reestablish a connection with the communication apparatus 102 in infra. Upon receipt of the beacon (M507), the communication apparatus 102 sends an association request (M508) to the communication apparatus 101 on the basis of information elements (network identifier, communication channel, etc.) included in the beacon. Upon receipt of the association request, the communication apparatus 101 sends an association response (M509) to the communication apparatus 102 in order to inform the communication apparatus 102 of acknowledgement of the connection. In this manner, establishment of the connection between the communication apparatuses 101 and 102 in infra is completed. After the processing to reestablish connection ends, communication using AES as an encryption method becomes possible (M510).

Although the processing in which the communication apparatus 101 operating in the AP mode is detected by a passive scan (method of searching the network by scanning a beacon) and a connection is established with the communication apparatus 101 has been described above, any other method of establishing a connection that would enable practice of the present invention is applicable.

Although the sequence illustrated in FIG. 5 depicts the case in which the communication mode is switched from ad hoc to infra, the communication mode can be switched from infra to ad hoc. Infra has a higher level of security than ad hoc. In infra, however, only an apparatus operating as an AP sends a beacon, and hence this apparatus consumes significant power. In contrast, apparatuses randomly send a beacon in ad hoc, and hence the power consumption varies negligibly among the apparatuses. In the case that WEP is employed, the power consumption of a dual apparatus can be reduced by performing communication in ad hoc.

For example, in the case that, during communication in infra (the communication apparatus 101 sets its operation mode to the AP mode), the communication apparatus 102 sends a request to change the encryption method to WEP by sending the encryption-method change request message (M501), the communication mode may be switched to ad hoc. In this case, the encryption-method change instruction message (M504) from the communication apparatus 101 includes an instruction to switch the communication mode to ad hoc. After the connection has been broken (M506), the communication apparatus 101 switches its operation mode from the AP mode to the terminal mode and switches its communication mode from infra to ad hoc. Accordingly, the communication apparatuses 101 and 102 can perform ad hoc communication (where the encryption method is WEP).

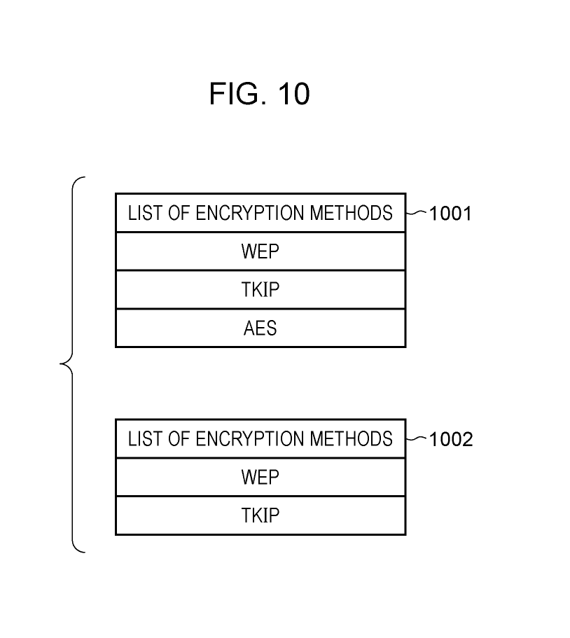

FIG. 10 illustrates other exemplary encryption methods supported by the communication apparatus 101 and the communication apparatus 102 in infra. The communication apparatus 101 supports WEP, TKIP, and AES, the communication apparatus 102 supports WEP and TKIP but does not support AES. Both the communication apparatuses 101 and 102 support only WEP in ad hoc.

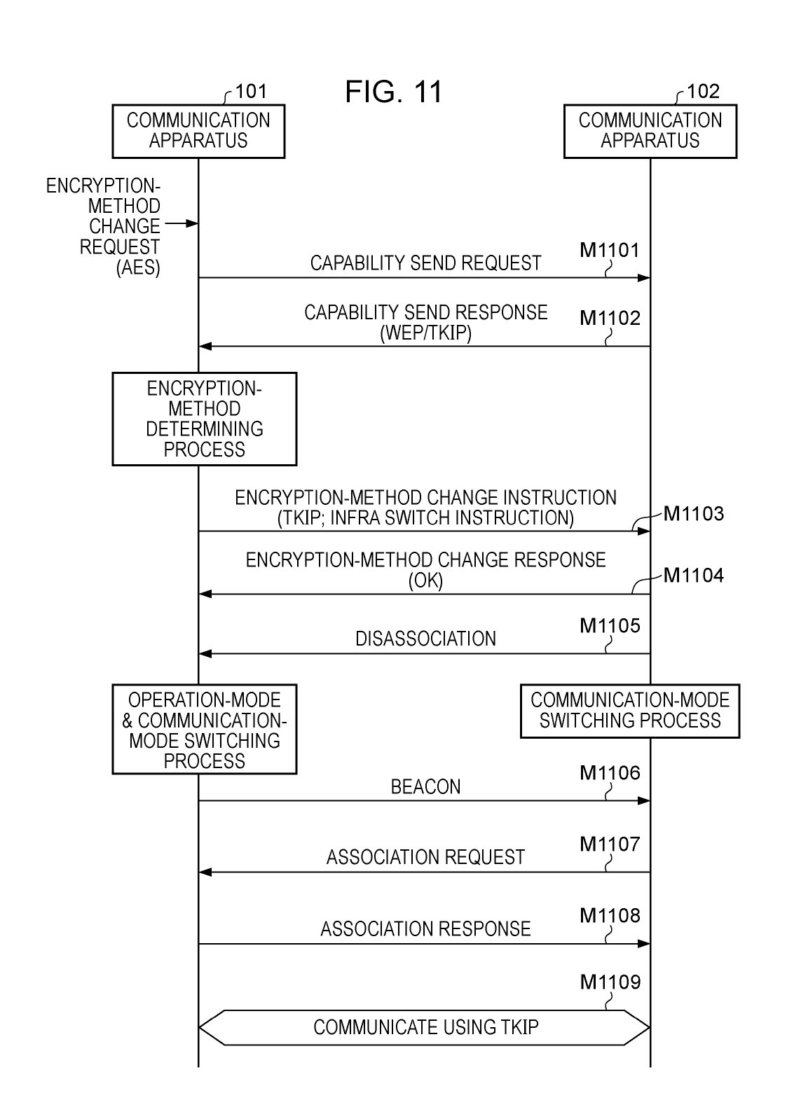

FIG. 11 is a diagram of an encryption-method changing sequence in the case that encryption methods supported by the communication apparatuses 101 and 102 are those illustrated in FIG. 10.

In this sequence, the operation mode of the communication apparatus 101 has been set to the terminal mode, and the communication apparatus 101 is communicating with the communication apparatus 102 in ad hoc (where the encryption method is WEP). The case in which an application running on the communication apparatus 101 serving as a dual apparatus sends a request to change the encryption method to AES, which is a stronger encryption method than WEP, will be described.

First, the communication apparatus 101 detects a request from the application to change the encryption method to AES. This change request occurs in the case that, for example, a user gives an instruction to change the encryption method.

Upon detection of the request to change the encryption method, the communication apparatus 101 sends a capability send request message (M1101) to the communication apparatus 102.

Upon receipt of the capability send request message (M1101), the communication apparatus 102 stores the encryption methods supported in infra by the communication apparatus 102 in a capability send response message (M1102) and sends the capability send response message (M1102) to the communication apparatus 101. As has been described above, according to the present embodiment, the communication apparatus 102 supports the encryption methods WEP and TKIP. Alternatively, the processing to collect the capability (M1101 and M1102) may be performed in advance, regardless of whether an encryption-method change request is made or not.

Upon receipt of the capability send response message (M1102), the communication apparatus 101 performs an encryption-method determining process. In the present embodiment, AES has been the encryption method requested by the communication apparatus 101. However, since AES is not supported by the communication apparatus 102, the encryption method cannot be changed to AES. In contrast, TKIP, which is an encryption method stronger than the currently used WEP, is supported by both the communication apparatus 101 and the communication apparatus 102. Thus, the communication apparatus 101 determines to change the encryption method to TKIP. To communicate using TKIP, the mode of communication between the communication apparatus 101 and the communication apparatus 102 must be changed from ad hoc to infra.

Although the changing of the encryption method to TKIP is automatically determined in this sequence, a user may be allowed to select the encryption method to use.

Next, the communication apparatus 101 sends an encryption-method change instruction message (M1103) including an instruction to change the encryption method to TKIP and an instruction to switch the communication mode to infra to the communication apparatus 102. Upon receipt of the encryption-method change instruction message (M1103), the communication apparatus 102 sends an encryption-method change response message (M1104) to the communication apparatus 101 in order to respond that the encryption method can be changed to TKIP.

Next, the communication apparatus 102 sends a disassociation (M1105) to the communication apparatus 101 to break the connection with the communication apparatus 101. The breaking processing is not limited to the disassociation (M1105) and may include processing required to reestablish connection.

After the connection has been broken, the communication apparatus 101 switches its operation mode to the AP mode and its communication mode to infra. After the connection has been broken, the communication apparatus 102 switches its operation mode to infra.

Next, the communication apparatus 101 sends a beacon (M1106) in order to reestablish a connection with the communication apparatus 102 in infra. Upon receipt of the beacon (M1106), the communication apparatus 102 sends an association request (M1107) to the communication apparatus 101 on the basis of information elements (network identifier, communication channel, etc.) included in the beacon. Upon receipt of the association request, the communication apparatus 101 sends an association response (M1108) to the communication apparatus 102 in order to inform the communication apparatus 102 of acknowledgement of the connection. In this manner, establishment of the connection between the communication apparatuses 101 and 102 in infra is completed. After the processing to reestablish connection ends, communication using TKIP as an encryption method becomes possible (M1109).

Although the processing in which the communication apparatus 101 operating in the AP mode is detected by a passive scan (method of searching the network by scanning a beacon) and a connection is established with the communication apparatus 101 has been described above, a connection may be established by another method. For example, the communication apparatus 101 operating in the AP mode can be detected by an active scan (method of searching the network by exchanging a probe request/response) and a connection with the communication apparatus 101 established.

Although the sequence illustrated in FIG. 11 depicts the case in which the communication mode is switched from ad hoc to infra, the communication mode can be switched from infra to ad hoc. As has been described above, the power consumption of the dual apparatus can be reduced in ad hoc communication compared with that in infra communication.

For example, in the case that, during communication in infra (the communication apparatus 101 sets its operation mode to the AP mode), the application running on the communication apparatus 101 sends a request to change the encryption method to WEP, the communication mode may be switched to ad hoc. In this case, the communication apparatus 101 includes an instruction to switch the communication mode to ad hoc in the encryption-method change instruction message (M1103), which is an instruction to change the encryption method to WEP, and sends the encryption-method change instruction message (M1103). After the connection has been broken (M1105), the communication apparatus 101 switches its operation mode from the AP mode to the terminal mode and switches its communication mode from infra to ad hoc. Accordingly, the communication apparatuses 101 and 102 can perform ad hoc communication (where the encryption method is WEP).

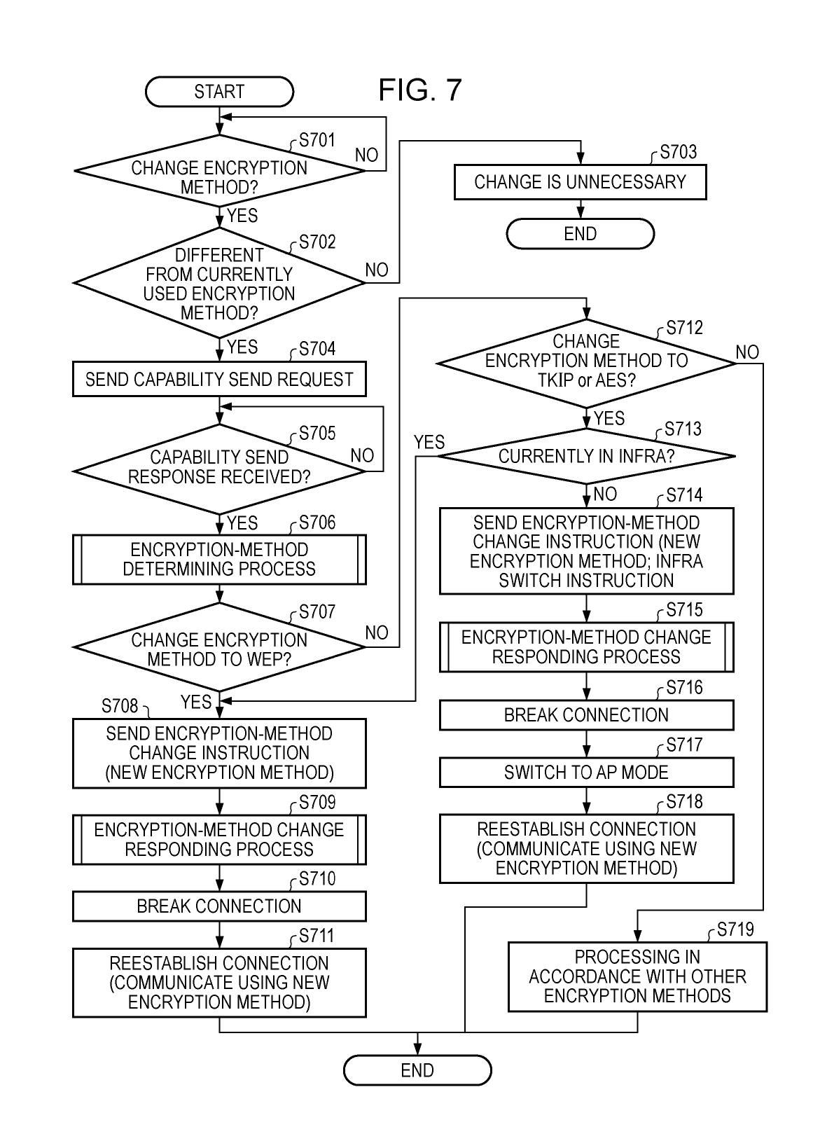

FIG. 7 is a flowchart of the operation flow of the communication apparatus 101. FIG. 9 is a flowchart of the operation flow of the communication apparatus 102.

In the case that the communication apparatus 102 sends a request to change its encryption method (yes in S901), the communication apparatus 102 sends an encryption-method change request message to the communication apparatus 101 (S906).

In the case that the communication apparatus 101 receives the encryption-method change request message from the communication apparatus 102 or detects an encryption-method change request from an application running on the communication apparatus 101 (yes in S701), the communication apparatus 101 determines whether the encryption method is different from a currently used encryption method (S702). If the communication apparatus 101 is not communicating with any apparatus, S702 may be skipped.

In the case that the requested encryption method is the same as the currently used encryption method (no in S702), the communication apparatus 101 informs the communication apparatus 102 that there is no need to change the encryption method (S703). Upon receipt of the change unnecessary response (yes in S907), the communication apparatus 102 ends the processing.

In the case that the requested encryption method is different from the currently used encryption method (yes in S702), the communication apparatus 101 sends a capability send request message to the communication apparatus 102 (S704).

Upon receipt of the capability send request message (yes in S902), the communication apparatus 102 sends a capability send response message including the encryption methods supported by the communication apparatus 102 in infra to the communication apparatus 101 (S903). Upon receipt of the capability send response message (yes in S705), the communication apparatus 101 performs an encryption-method determining process (S706). Regardless of whether to change the encryption method or not, the processing to collect the capability (S704, S705, S902, and S903) may be performed in advance.

The encryption-method determining process will be described in detail with reference to FIG. 6.

First, the communication apparatus 101 determines whether the requested encryption method is supported by both the communication apparatus 101 and the communication apparatus 102 (S601).

In the case that the requested encryption method is supported by both the communication apparatuses 101 and 102 (yes in S601), the communication apparatus 101 determines to change the encryption method to the requested encryption method (S602) and informs the application thereof (S603).

In the sequence illustrated in FIG. 5, the encryption method requested by the communication apparatus 102 is AES. Since the communication apparatus 101 supports AES, the communication apparatus 101 determines to change the encryption method to AES.

In the case that the requested encryption method is not supported by both the communication apparatus 101 and the communication apparatus 102 (no in S601), the communication apparatus 101 checks whether an encryption method stronger than the currently used encryption method is supported by both the communication apparatus 101 and the communication apparatus 102 (S604).

In the case that such a common encryption method is supported by both the communication apparatuses 101 and 102 (yes in S604), the communication apparatus 101 determines to change the encryption method to the common encryption method (S605) and informs the application thereof (S606).

In the case that a common encryption method stronger than the currently used encryption method is not supported by both the communication apparatuses 101 and 102 (no in S604), the communication apparatus 101 informs the application that the encryption method cannot be changed (S607).

In the sequence illustrated in FIG. 11, AES, which is requested by the communication apparatus 101, is not supported by the communication apparatus 102. However, since TKIP, which has higher encryption strength than the currently used WEP, is supported by both the communication apparatuses 101 and 102, the communication apparatus 101 determines to change the encryption method to TKIP.

Returning to the description of FIGS. 7 and 9, once the encryption method to use is determined by the encryption-method determining process (S706), the processing performed by the communication apparatus 101 is divided into two routines (S707 and S712) on the basis of the determined encryption method.

In the case that the encryption method is to be changed to WEP (yes in S707), the communication apparatus 101 sends an encryption-method change instruction message to change the encryption method to WEP to the communication apparatus 102 (S708).

In the case that the encryption method is to be changed to TKIP or AES (no in S707 and yes in S712), the communication apparatus 101 determines whether the communication apparatus 101 is currently communicating in infra (S713).

In the case that the communication apparatus 101 is communicating in infra (yes in S713), the flow proceeds to S708, and the communication apparatus 101 sends an encryption-method change instruction message to the communication apparatus 102.

In the case that the communication apparatus 101 is communicating in ad hoc (no in S713), the communication apparatus 101 sends an encryption-method change instruction message including an instruction to switch the communication mode to infra to the communication apparatus 102 (S714).

Upon receipt of the encryption-method change instruction message (yes in S904), the communication apparatus 102 informs an application running thereon of the reception of the encryption-method change instruction message (S905).

To acknowledge the encryption-method change (yes in S908), the communication apparatus 102 sends an encryption-method change response message including the acknowledgement to the communication apparatus 101 (S909). In the case that the encryption-method change is not allowed (no in S908), the communication apparatus 102 sends an encryption-method change response message including refusal to the communication apparatus 101 (S910).

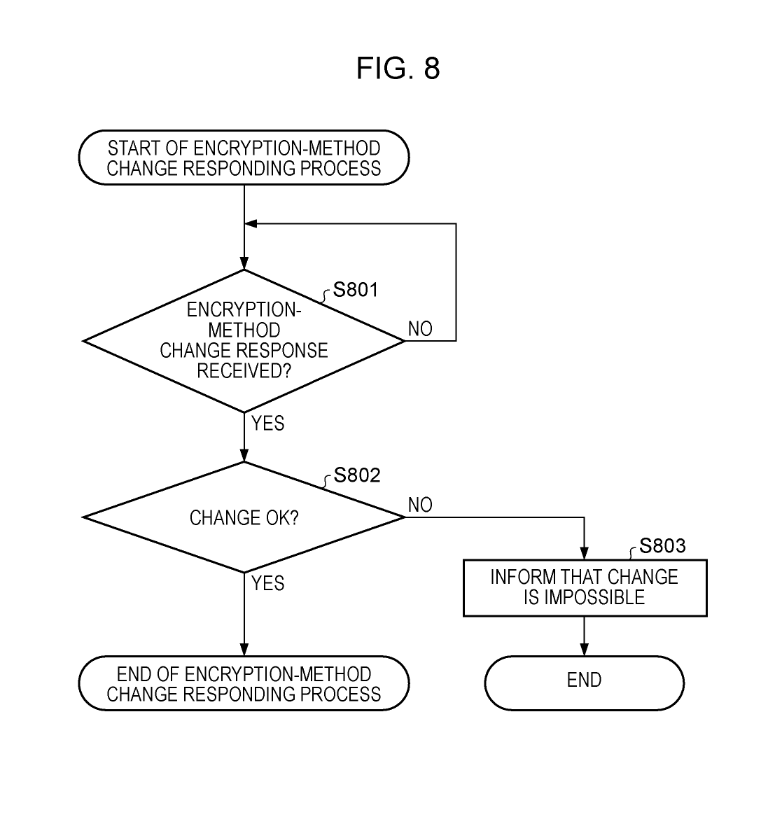

After sending the encryption-method change instruction message (S708 or S714), the communication apparatus 101 performs an encryption-method change responding process (S709 or S715). The encryption-method change responding process will be described in detail with reference to FIG. 8.

Upon reception of the encryption-method change response message (yes in S801), the communication apparatus 101 determines whether the encryption method can be changed (S802).

In the case that the encryption method can be changed (yes in S802), the communication apparatus 101 ends the encryption-method change responding process and proceeds to the next step (S710 or S716). In the case that the encryption method cannot be changed (no in S802), the communication apparatus 101 informs the application running thereon of the fact that the encryption method cannot be changed (S803) and ends the flow.

Returning to FIGS. 7 and 9, in the case that the encryption method can be changed, the processing to break connection between the communication apparatus 101 and the communication apparatus 102 is performed (S710 or S716 and S911).

After the connection has been broken in S710, since it is unnecessary to change the communication mode, n step S711, the communication apparatus 101 performs processing to reestablish a connection with the communication apparatus 102 using a new encryption method.

After the connection has been broken in S716, the communication apparatus 101 changes its operation mode to the AP mode in S717, and performs processing to reestablish a connection with the communication apparatus 102 using a new encryption method (S718).

After the connection has been broken in step S911, in the case that the encryption-method change instruction message includes an instruction to change the communication mode, the communication apparatus 102 changes its communication mode (S913). Thereafter, the communication apparatus 102 performs processing to reestablish a connection with the communication apparatus 101 using a new encryption method (S914).

In the case that the encryption-method change instruction message includes no instruction to change the communication mode (no in S912), the communication apparatus 102 maintains the current communication mode and performs processing to reestablish a connection with the communication apparatus 101 using a new encryption method (S914).

In the case that the encryption method is to be changed to an encryption method other than WEP, TKIP, and AES in S712 (no in S712), unique processing according to the desired encryption method is performed (S719).

Although the encryption-method change instruction messages (M504 and M1103) each include the instruction to switch the communication mode to infra in the present embodiment, the encryption-method change instruction messages (M504 and M1103) do not include such an instruction to switch the communication mode. For example, in the case that a change instruction message to change the encryption method to TKIP or AES is received, the communication mode may be set in advance to be switched to infra.

According to the present embodiment, communication in a communication mode according to the encryption method to be used can be implemented by appropriately switching the operation mode and the communication mode of each communication apparatus.

According to the present embodiment, in the case that, while two communication apparatuses are communicating with each other in ad hoc (where the encryption method is WEP), one communication apparatus issues a request to change the encryption method to an encryption method with higher encryption strength, such as TKIP or AES, the dual apparatus switches its operation mode to the AP mode and switches its communication mode to infra for direct communication. Thus, even in the case of one-to-one direct communication, more secure communication can be implemented.

Even in the case that the requested encryption method is not supported by one of the communication apparatuses, the encryption method can be changed to an encryption method with the highest encryption strength among encryption methods supported by both the communication apparatuses. Thus, highly secure communication can be implemented while requiring less complicated user operation.

In the case that one of the communication apparatuses sends a request to change the encryption method to WEP during communication in infra in which the dual apparatus operates in the AP mode, the dual apparatus switches its operation mode to the terminal mode, whereby communication in ad hoc becomes possible. Thus, in the case that an encryption method that can also be supported in ad hoc is used, the communication mode is switched to ad hoc, thereby reducing the power consumption of the dual apparatus. Accordingly, wireless communication in a communication mode taking into consideration the security level and the power consumption can be implemented by switching the operation mode of the dual apparatus.

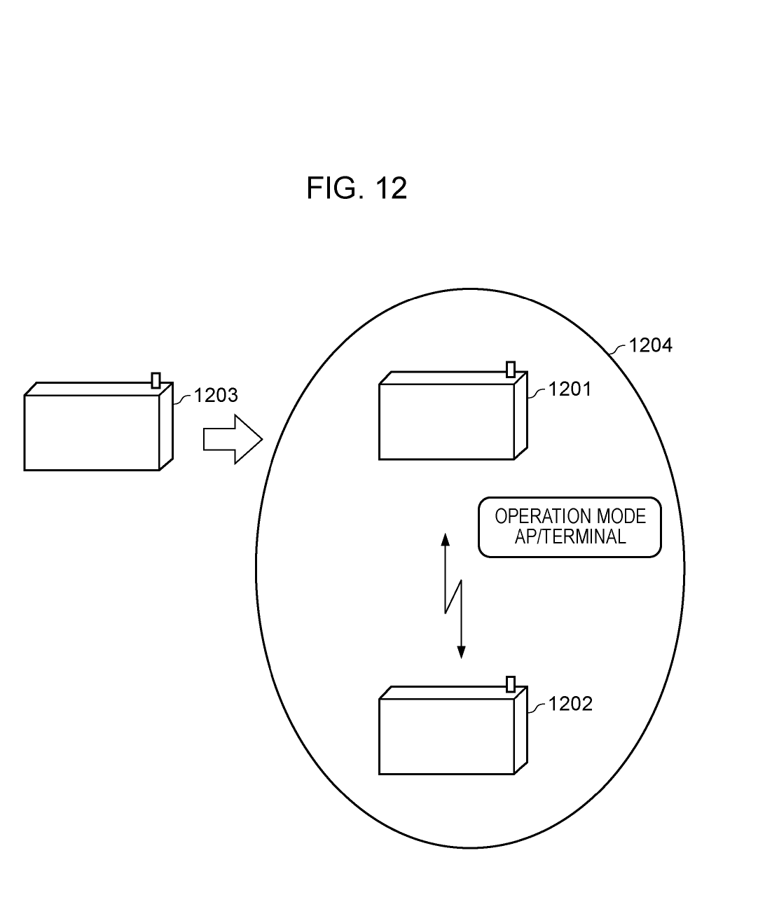

FIG. 12 illustrates a system configuration according to a second embodiment of the present invention.

A communication apparatus 1201 is a dual apparatus and has a structure similar to that of the communication apparatus 101 according to the first embodiment. Communication apparatuses 1202 and 1203 are legacy apparatuses and each have a structure similar to that of the communication apparatus 102 according to the first embodiment.

Both the communication apparatuses 1201 and 1203 support encryption methods described in an encryption method list 1001 (FIG. 10) in infra. The communication apparatus 1202 supports encryption methods described in an encryption method list 1002 (FIG. 10) in infra. The communication apparatuses 1201 to 1203 support only WEP in ad hoc.

The operation mode of the communication apparatus 1201 has been set to the terminal mode. The communication apparatus 1201 forms an ad hoc network 1204 with the communication apparatus 1202 and is communicating with the communication apparatus 1202 using WEP.

The case in which the communication apparatus 1203 newly participates in the network 1204 and requests communication using AES as the encryption method will now be described.

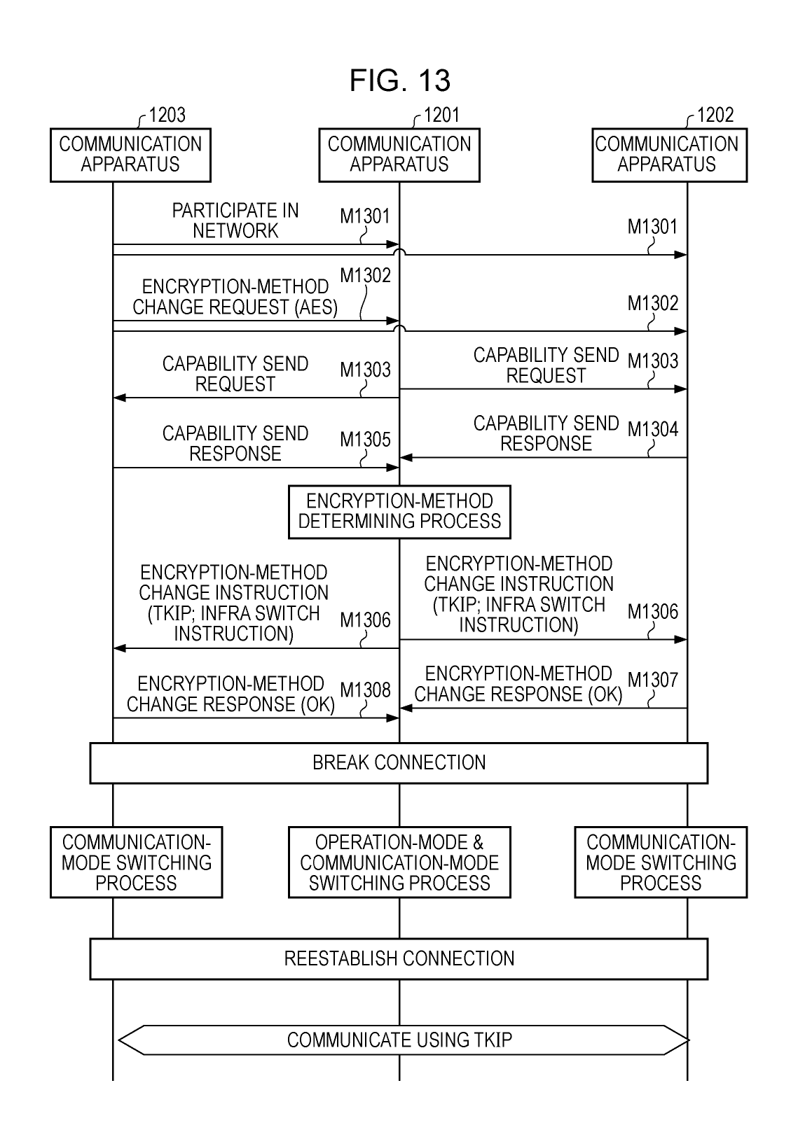

FIG. 13 is a sequence diagram among the communication apparatuses 1201 to 1203 according to the present embodiment.

Since the operation flow of the communication apparatus 1201 according to the present embodiment is similar to the operation flow (FIGS. 6 through 8) of the communication apparatus 101 according to the previous embodiment, a description herein is omitted. Since the operation flow of the communication apparatuses 1202 and 1203 is similar to the operation flow (FIG. 9) of the communication apparatus 102 according to the previous embodiment, a description herein is omitted.

First, the communication apparatus 1203 participates in the network 1204 (M1301). Thereafter, the communication apparatus 1203 sends an encryption-method change request message (M1302) to change the encryption method to AES to the communication apparatuses 1201 and 1202.

Upon receipt of the encryption-method change request message (M1302), the communication apparatus 1201 sends a capability send request message (M1303) to the communication apparatuses 1202 and 1203.

In the case that the communication apparatus 1202 also receives the encryption-method change request message (M1302), the communication apparatus 1202 may send a response or may ignore the message.

Upon receipt of the capability send request message (M1303), the communication apparatuses 1202 and 1203 send capability send response messages (M1304 and M1305), respectively, including the encryption methods supported by the communication apparatuses 1202 and 1203 in infra, to the communication apparatus 1201. As described above, the communication apparatus 1201 supports WEP, TKIP, and AES in infra. In contrast, the communication apparatus 1202 supports WEP and TKIP in infra, but does not support AES.

Upon receipt of the capability send response messages (M1304 and M1305), the communication apparatus 1201 performs an encryption-method determining process. Regarding this process, since the process described in the previous embodiment is performed, a description herein is omitted.

In this sequence, since the communication apparatus 1202 does not support AES, the encryption method cannot be changed to AES. Thus, the communication apparatus 1201 determines to change the encryption method to, among the encryption methods supported by all the communication apparatuses 1201 to 1203, TKIP, which is an encryption method with higher encryption strength than the currently used WEP.

The communication apparatus 1201 sends an encryption-method change instruction message (M1306) including an instruction to change the encryption method to TKIP and an instruction to switch the communication mode to infra to the communication apparatuses 1202 and 1203.

Upon receipt of the encryption-method change instruction message (M1306), the communication apparatuses 1202 and 1203 send encryption-method change response messages (M1307 and M1308), respectively, to the communication apparatus 1201 in order to inform the communication apparatus 1201 that the encryption method can be changed.

Upon receipt of the encryption-method change response messages (M1307 and M1308), the communication apparatus 1201 confirms that both the communication apparatuses 1202 and 1203 can be changed to TKIP. Thereafter, the communication apparatuses 1201 to 1203 break the communication. The communication apparatus 1201 switches its operation mode to the AP mode and its communication mode to infra. The communication apparatuses 1202 and 1203 switch their communication modes to infra.

In this manner, the communication apparatuses 1201 to 1203 perform processing to reestablish connection in infra, whereby the communication apparatuses 1201 and 1203 can communicate with one another using TKIP.

In the case that either of the communication apparatuses 1202 and 1203 cannot be changed to the requested encryption method, the encryption method is not changed, and the sequence is terminated. For example, in the case that the communication apparatus 1202 sends a response that the change is possible and the communication apparatus 1203 sends a response that the change is impossible, the communication apparatus 1202 is informed that the encryption method will not be changed. Accordingly, the communication apparatus 1202 is prevented from breaking the communication.

According to the present embodiment, in the case that the communication apparatus 1203, which has newly participated in the network, sends a request to change the encryption method to AES, the communication apparatus 1201 collects the encryption methods supported by each apparatus and determines the encryption method to use. Alternatively, the encryption method may be changed at a different time. For example, the communication apparatus 1201 may change the encryption method at the time that the participation of the communication apparatus 1203 in the network is detected.

Although the encryption-method change instruction message (M1306) includes the instruction to switch the communication mode to infra in the second embodiment, the message may not include such a switching instruction. For example, in the case that a change instruction message to change the encryption method to TKIP or AES is received, the communication mode may be set in advance to be switched to infra.

Although the case in which the communication mode is changed from ad hoc to infra based on the encryption-method change request issued by a communication apparatus that has newly participated in a network has been described in the present embodiment, the communication mode may be changed from infra to ad hoc. For example, in the case that a communication apparatus newly participates in a network during communication in infra (where the encryption method is AES) and issues a request to change the encryption method to WEP, the dual apparatus switches its operation mode to the terminal mode, whereby communication in ad hoc (where the encryption method is WEP) becomes possible.

According to the present embodiment, communication in a communication mode according to the encryption method to be used can be implemented by appropriately switching the operation mode and the communication mode of each communication apparatus.

According to the present embodiment, in the case that, while two communication apparatuses are communicating with each other in ad hoc, another communication apparatus participates in the network and requests to communicate using a stronger encryption method, the dual apparatus switches its operation mode to the AP mode, whereby communication in infra becomes possible. Thus, even in the case that three or more apparatuses participate in the network, highly secure communication can be implemented.

When changing the encryption method, the encryption method to use can be determined based on the encryption methods supported by each communication apparatus in the network. If even one of the communication apparatuses does not support an encryption method requested by any of the communication apparatuses, the encryption method can be changed to, among the encryption methods supported by all the communication devices, an encryption method with the highest encryption strength.

In the case that a new communication apparatus issues a request to change the encryption method to WEP during communication in infra, the dual apparatus switches its operation mode to the terminal mode, whereby communication in ad hoc becomes possible. Thus, in the case that an encryption method that can also be supported in ad hoc is used, the communication mode is switched to ad hoc, thereby reducing the power consumption of the dual apparatus. Accordingly, wireless communication in a communication mode taking into consideration the security level and the power consumption can be implemented by switching the operation mode of the dual apparatus.

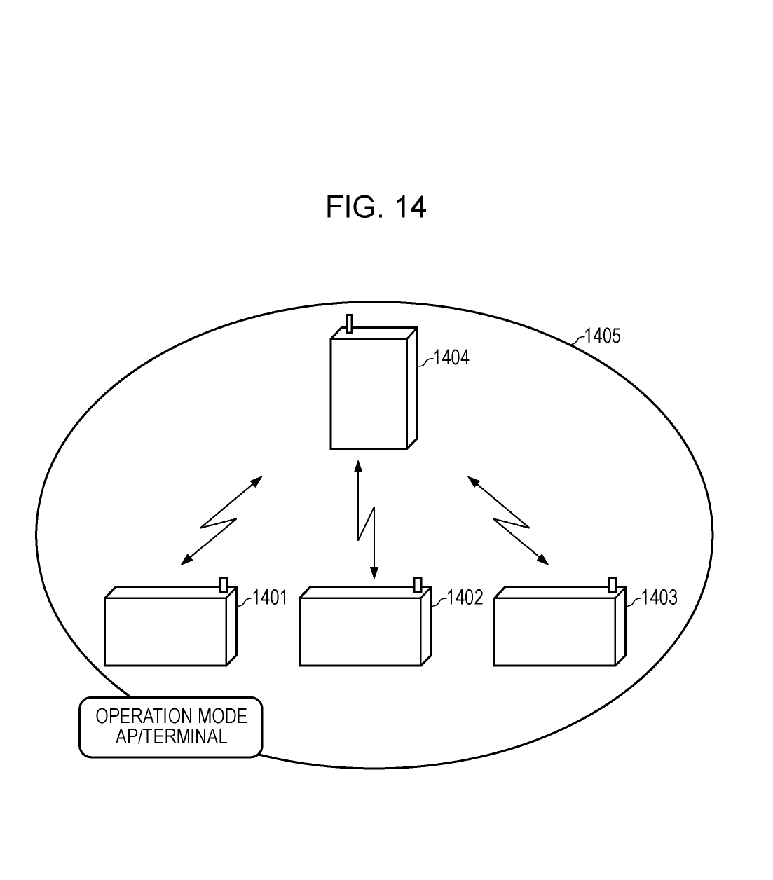

FIG. 14 illustrates a system configuration according to a third embodiment of the present invention.

A communication apparatus 1401 is a dual apparatus and has a structure similar to that of the communication apparatus 101 according to the first embodiment. Communication apparatuses 1402 and 1403 are legacy apparatuses and each have a structure similar to that of the communication apparatus 102 according to the first embodiment. With an access point 1404, an infra network 1405 is formed.

The operation mode of the communication apparatus 1401 has been set to the terminal mode. The communication apparatus 1401 is communicating with the communication apparatuses 1402 and 1403 via the access point 1404.

The communication apparatuses 1401 to 1403 and the access point 1404 support encryption methods described in the encryption method list 1001 (FIG. 10) in infra. The communication apparatuses 1401 to 1403 support only WEP in ad hoc.

According to the present embodiment, the processing in the case in which the necessity of direct communication between the communication apparatus 1401 and the communication apparatus 1402 arises due to some conditions (e.g., the band becomes insufficient) will be described.

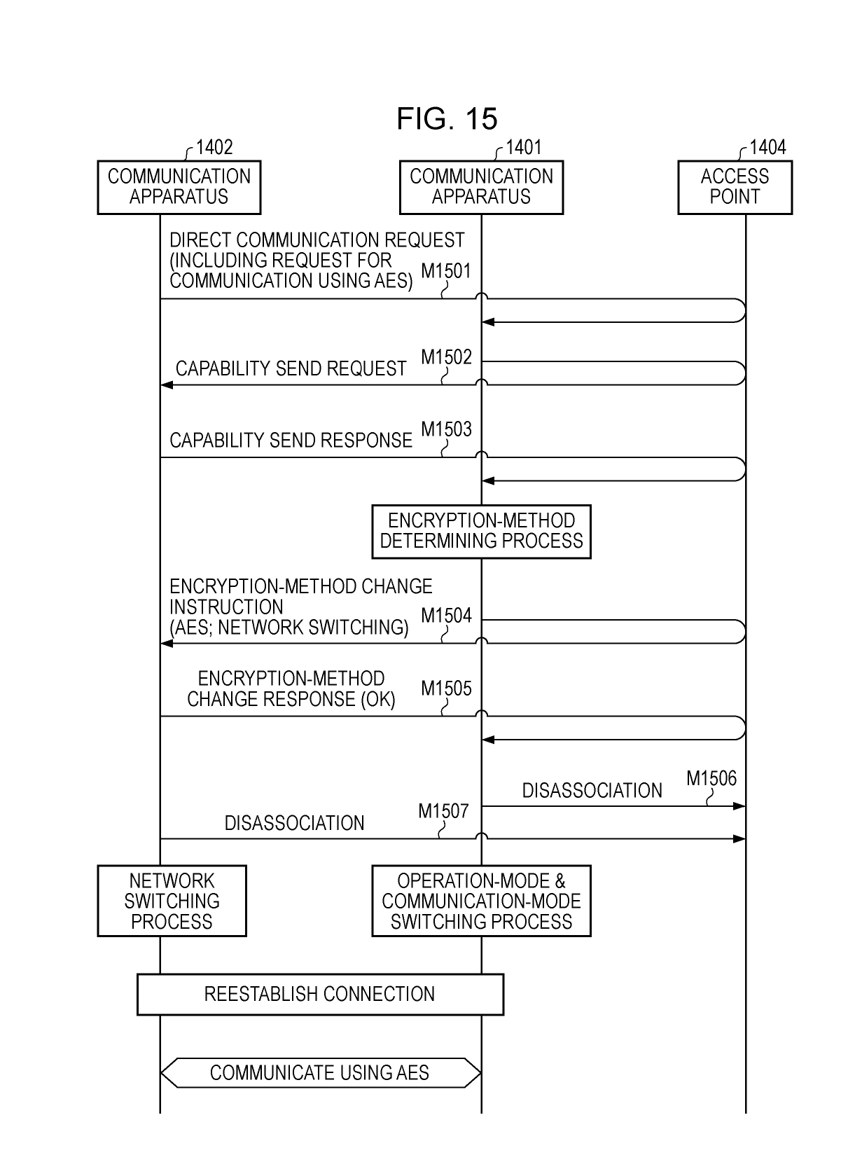

FIG. 15 is a sequence diagram among the communication apparatus 1401, the communication apparatus 1402, and the access point 1404. Since the communication apparatus 1403 does not directly relate to this processing, a description thereof is omitted.

In the case that the necessity of direct communication with the communication apparatus 1401 arises during infra-communication, the communication apparatus 1402 sends a direct communication request message (M1501) to the communication apparatus 1401. In this case, the direct communication request message (M1501) includes a request for communication using AES.

Upon receipt of the direct communication request message (M1501), the communication apparatus 1401 sends a capability send request message (M1502) to the communication apparatus 1402.

Upon receipt of the capability send request message (M1502), the communication apparatus 1402 sends a capability send response message (M1503) including encryption methods supported in infra to the communication apparatus 1401. As has been described above, the communication apparatus 1402 supports WEP, TKIP, and AES in infra. The capability send response message (M1503) may include parameters (network identifier, communication channel, etc.) needed for direct communication.

Upon receipt of the capability send response message (M1503), the communication apparatus 1401 performs an encryption-method determining process. Regarding this process, the process described in the first embodiment is performed. In this sequence, since both the communication apparatuses 1401 and 1402 support AES, the communication apparatus 1401 determines to directly communicate with the communication apparatus 1402 using AES.

Thus, the communication apparatus 1401 sends an encryption-method change instruction message (M1504) including an instruction to change the encryption method to AES and an instruction to switch the network to the communication apparatus 1402. The encryption-method change instruction message (M1504) may include new network parameters (network identifier, communication channel, etc.) needed for direct communication.

Upon receipt of the encryption-method change instruction message (M1504), the communication apparatus 1402 informs an application running thereon of the message and performs processing to check whether the encryption method can be changed. In this sequence, the communication apparatus 1402 sends an encryption-method change response message (M1505) to the communication apparatus 1401 to inform the communication apparatus 1401 that the encryption method can be changed to AES.

Upon receipt of the encryption-method change response message (M1505), the communication apparatus 1401 sends a disassociation (M1506) to break the connection with the access point 1404. Similarly, the communication apparatus 1402 sends a disassociation (M1507) to the access point 1404 to break the connection with the access point 1404.

Alternatively, the communication apparatuses 1401 and 1402 may send a disassociation after asking the communication apparatus 1403 whether the communication apparatuses 1401 and 1402 are allowed to break the connection.

After the connection has been broken (M1506 and M1507), the communication apparatus 1402 performs processing to switch the network. More specifically, the communication apparatus 1402 sets parameters (e.g., network identifier, communication channel, etc.) for direct communication with the communication apparatus 1401.

The communication apparatus 1401 performs processing to switch its operation mode and communication mode. More specifically, the communication apparatus 1401 switches its operation mode to the AP mode and sets communication parameters for direct communication with the communication apparatus 1402.

The communication apparatuses 1401 and 1402 perform processing to reestablish a connection therebetween, whereby the communication apparatuses 1401 and 1402 can directly communicate with each other in infra (where the encryption method is AES).

Although the case in which the communication apparatus 1402 sends a request to directly communicate with the communication apparatus 1401 using AES has been described in the present embodiment, the case of a request for direct communication using another encryption method can also be performed.

For example, in the case of a request for direct communication using WEP, the communication apparatus 1401 may directly communicate with the communication apparatus 1402 in ad hoc without switching its operation mode. By performing communication in ad hoc, the communication apparatus 1401 serving as the dual apparatus consumes less power than communicating in the AP mode.

According to the present embodiment, communication in a communication mode according to the encryption method to be used can be implemented by appropriately switching the operation mode and the communication mode of each communication apparatus.

According to the present embodiment, in the case that, while two communication apparatuses are communicating with each other via an access point, the necessity of direct communication between the two communication apparatuses arises, direct communication in one of the communication modes, that is, ad hoc or infra, according to the encryption method to be used can be implemented.

In the above-described embodiments, the case in which the operation mode and the communication mode are switched depending on which one of the encryption methods WEP, TKIP, and AES is used has been described. However, the present invention is also applicable to other encryption methods. For example, selecting a key generating algorithm with high encryption strength may be set as a switching condition.

In the above-described embodiments, the case in which there is one dual apparatus in the network has been described. However, the present invention is also applicable to the case in which there are multiple dual apparatuses in the network. In such a case, any one of the dual apparatuses may be required to perform processing to switch the operation mode according to the above-described embodiments.

In the above-described embodiments, the case of the wireless LAN communication has been described. However, the present invention is also applicable to other wireless communication systems, such as ultra wide band (UWB).

Thus, according to the above-described embodiments, communication in a communication mode suitable for an encryption method to be used can be implemented by switching between the AP mode and the terminal mode of the dual apparatus. For example, even in the case of one-to-one communication, an encryption method such as AES or TKIP can be used, ensuring highly secure communication.

In this manner, according to the above-described embodiments, communication in a communication mode according to an encryption method to be used can be implemented.

The scope of the present invention also includes the case where software program code for implementing the features of the above-described embodiments is supplied to a computer (a CPU or a microprocessor unit (MPU)) of an apparatus or system connected to various devices such that the devices can be operated to implement the features of the above-described embodiments, and the devices are operated according to the program stored in the computer of the system or apparatus.

In this case, the software program code itself implements the features of the above-described embodiments, and the program code itself and a device for supplying the program code to the computer, such as a recording medium storing the program code, constitute an embodiment of the present invention. Recording media storing the program code include, but are not limited to, a floppy disk, a hard disk, an optical disk, a magneto-optical disk, a compact disk read-only memory (CD-ROM), a magnetic tape, a non-volatile memory card, and a ROM.

The features of the above-described embodiments are implemented by the computer executing the supplied program code. Further, in the case where the program code cooperates with an operating system (OS) running on the computer or other application software to implement the features of the above-described embodiments, the program code is included in an embodiment of the present invention.

The present invention may also include the case where the supplied program code is stored in a memory of a function expansion board of the computer, and thereafter a CPU included in the function expansion board executes part or the entirety of actual processing in accordance with an instruction of the program code, whereby the features of the above-described embodiments are implemented.

Further, the present invention may also include the case where the supplied program code is stored in a memory of a function expansion unit connected to the computer, and thereafter a CPU included in the function expansion unit executes part or the entirety of actual processing in accordance with an instruction of the program code, whereby the features of the above-described embodiments are implemented.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Application No. 2006-208494 filed Jul. 31, 2006, which is hereby incorporated by reference herein in its entirety.

What is claimed is:

1. A communication system comprising:
a first communication apparatus; and
a second communication apparatus,
wherein the first and second communication apparatuses each include a first operation mode in which the first and second communication apparatuses operate as a control station in a wireless network, and a second operation mode in which the first and second communication apparatuses operate as a terminal station in the wireless network,
wherein an encryption method to be used for communication between the first and second communication apparatuses is determined, and the first communication apparatus selectively switches between the first and second operation modes based on the determined encryption method, and the first and second communication apparatuses communicate with each other using the determined encryption method and the switched operation mode.

2. A communication apparatus including a first operation mode in which the communication apparatus operates as a control station in a wireless network and a second operation mode in which the communication apparatus operates as a terminal station in the wireless network, the communication apparatus comprising:
a determining unit configured to determine an encryption method to use for communication;
a switching unit configured to selectively switch between the first and second operation modes based on the encryption method determined by the determining unit; and
a communication unit configured to communicate in the operation mode switched to by the switching unit.

3. A communication apparatus according to claim 2, wherein the determining unit determines the encryption method to use in response to a request to change the encryption method.

4. A communication apparatus according to claim 2, wherein the determining unit determines the encryption method to use based on an encryption method supported by another communication apparatus.

5. A communication apparatus according to claim 2, further comprising a collecting unit configured to collect capability information regarding another communication apparatus in the wireless network in response to a request to change the encryption method,
wherein the determining unit determines the encryption method to use based on the capability information collected by the collecting unit.

6. A communication apparatus according to claim 2, wherein the communication apparatus communicates in a first communication mode in which terminal stations in the wireless network communicate with each other via the control station in the wireless network and a second communication mode in which the terminal stations directly communicate with each, and
wherein the communication unit communicates in one of the first and second communication modes in accordance with the operation mode switched to by the switching unit.

7. A communication apparatus according to claim 2, further comprising an informing unit configured to inform another communication apparatus of the encryption method determined by the determining unit.

8. A communication apparatus having a first communication mode in which terminal stations in a wireless network communicate with each other via a control station in the wireless network and a second communication mode in which the terminal stations directly communicate with each other, the communication apparatus comprising:
a determining unit configured to determine an encryption method to use for communication;
a switching unit configured to selectively switch between the first and second communication modes based on the encryption method determined by the determining unit; and
a communication unit configured to communicate in the communication mode switched to by the switching unit.

9. A method for controlling a communication apparatus including a first operation mode in which the communication apparatus operates as a control station in a wireless network and a second operation mode in which the communication apparatus operates as a terminal station in the wireless network, the method comprising:
determining an encryption method to use for communication;
selectively switching between the first and second operation modes based on the determined encryption method; and
communicating in the switched operation mode.

10. A computer-readable storage medium storing computer-executable process steps, the computer-executable process steps causing a computer to execute the method of claim 9.

11. A method for controlling a communication apparatus including a first communication mode in which terminal stations in a wireless network communicate with each other via a control station and a second communication mode in which the terminal stations directly communicate with each other, the method comprising:
determining an encryption method to use for communication;
selectively switching between the first and second communication modes based on the determined encryption method; and
communicating in the switched communication mode.

12. A computer-readable storage medium storing computer-executable process steps, the computer-executable process steps causing a computer to execute the method of claim 11.
